(19) United States
(12) Patent Application Publication
(10) Pub. No.: US 2006/0282871 A1
(43) Pub. Date: Dec. 14, 2006

(54) Distribution method for noise control

(76) Inventor: Yao-Tsan Yo, Nantou County (TW)

Correspondence Address: BIRCH STEWART KOLASCH & BIRCH, PO BOX 747, FALLS CHURCH, VA, 22040-0747, US

(21) Appl. No.: 11/150,247

(22) Filed: Jun. 13, 2005

(51) Int. Cl. H04N 7/173

(52) U.S. Cl. 725/124; 725/123; 725/125

(57) ABSTRACT

The present invention discloses a distribution method for noise control, which is employed to adjust the attenuated amount of an upstream signal passing from the machine room's end to a user's end. The method is to emit a simulation signal from a user's end, and the simulation signal will be transmitted to a machine room's end through a cable TV line for calculating the attenuated amount of the upstream signal passing from the user's end to the machine room's end. Then, the signal attenuated amount of the attenuator can be adjusted according to the attenuated amount of the upstream signal. Therefore, the power of the upstream signal at the user's end can be optimal so as to avoid noise interference.

### FIELD OF THE INVENTION

The present invention relates to a distribution method for noise control and, more particularly, to a method for adjusting the attenuated amount of an upstream signal that is passing from a machine room's end to a user's end so that the user may receive an upstream signal with optimal power and the upstream signal can avoid being interfered by the noise.

### BACKGROUND OF TEE INVENTION

Cable television is a system that, in a certain area, transmits downstream signals to its user's end for the subscribers to view TV programs. Cable television is very popular with its viewers because they can have a diversity of programs to choose from for watching, while installation of such system is quite simple. To acquire a good viewing quality, a subscriber only has to have the cable TV line connected, plus an amplifier planted appropriately, and then the subscriber can enjoy the provided programs.

FIG. 1 PRIOR ART is a block diagram illustrating a conventional cable TV system. Referring to FIG. 1 PRIOR ART, the machine room's end 1 utilizes a cable TV line 2 to transmit a downstream signal, and then the downstream signal can be transmitted to a user's end 6 through a major trunk amplifier 3, a major trunk distributor 4, and a splitter 5. On the other hand, the cable TV line 2 utilizes the major trunk amplifier 3 to maintain the downstream signal in a state of stable power, and then the downstream signal can be transmitted to the user's end 6 by means of major trunk distributor 4 and splitter 5. As to the functions of the cable TV line, it can do more than just transmitting downstream signals. As long as a cable modem 8 is installed into the cable TV system at the user's end and a Cable Modem Terminal System (CMTS, not shown) is installed at the machine room's end 1, the user's end can tansmit an upstream signal to the CMTS at the machine room's end 1 through the cable TV line 2 so as to logon to the Internet.

Both downstream and upstream signals passing through the cable TV line 2 are analogue signals. Also, as the cable TV line 2 is to be provided in different residences, one user's end 6 may have different line requirement and signal interference environment from another user's end. Consequently, the attenuated amount of upstream signal passing from each user's end 6 to the machine room's end 1 may be different. If, however, the attenuated amount of the upstream signal becomes too small, the upstream noise at the user's end 6 will become too large, which in turn can result in an excessive amount of noise at the machine room's end 1. As a result, all the upstream signals will become unrecognizable.

Therefore, in order to maintain a good quality of received images and recognizable upstream signals at the user's end 6, a conventional cable TV system may employ a CMTS located at the machine room's end 1 to receive an upstream signal from the user's end 6 and then emit a downstream signal according to the power of the upstream signal so as to adjust the power of the upstream signal to an optimal amount. If, however, the attenuated amount of the upstream signal from the user's end 6 is too small, resulting in excessive upstream noise at the user's end, then the noise in the machine room's end 1 will become excessive as well, making all the upstream signals become unrecognizable. As the above mentioned, the line requirement and signal interference environment at one user's end may be different from that of another user's end. Therefore, there is no certain standard set up for the attenuated amount of the upstream signal from the user's end 6 to the machine room's end 1, making it quite impossible for the upstream signal attenuation to be adjusted to its optimal amount. If signal interference around the user's living environment has changed, the upstream signal at the user's end will become unrecognizable, which may cause a failure in logging onto the Internet. Eventually, the failure problem will go to the provider of cable TV system for finding a solution and therefore will increase the system provider's maintenance cost.

### SUMMARY OF THE INVENTION

In viewing of the above-mentioned problem, the main object of the present invention is to provide a distribution method for noise control that is capable of making the attenuated amount of an upstream signal passing from a user's end to the machine room's end to be optimal so as to prevent the upstream signal at the user's end from being interfered by the noise.

The present invention discloses a distribution method for noise control, which is employed to adjust the attenuated amount of an upstream signal passing from a machine room's end to a user's end by firstly emitting a simulation signal from the user's end, and then the simulation signal will be transmitted to the machine room's end through a cable TV line and a splitter; next, the machine room's end will receive the simulation signal and measure its power so as to calculate and obtain the attenuated amount of the upstream signal from the user's end to the machine room's end; besides, an attenuator is included in the splitter for adjusting the signal attenuation so that the attenuated amount of the upstream signal from the user's end to the machine room's end can be used to adjust the signal attenuation of the attenuator; therefore, the attenuated amount of the upstream signal from the user's end to the machine room's end can remain in a fixed amount, thereby preventing the user's end from being interfered by the upstream noise as well as resolving the problem of unrecognizable upstream signals caused by the excessive amount of noise at the machine room's end.

### BRIEF DESCRIPTION OF THE DRAWINGS

FIG. 1 PRIOR ART is a block diagram illustrating a conventional cable TV system.

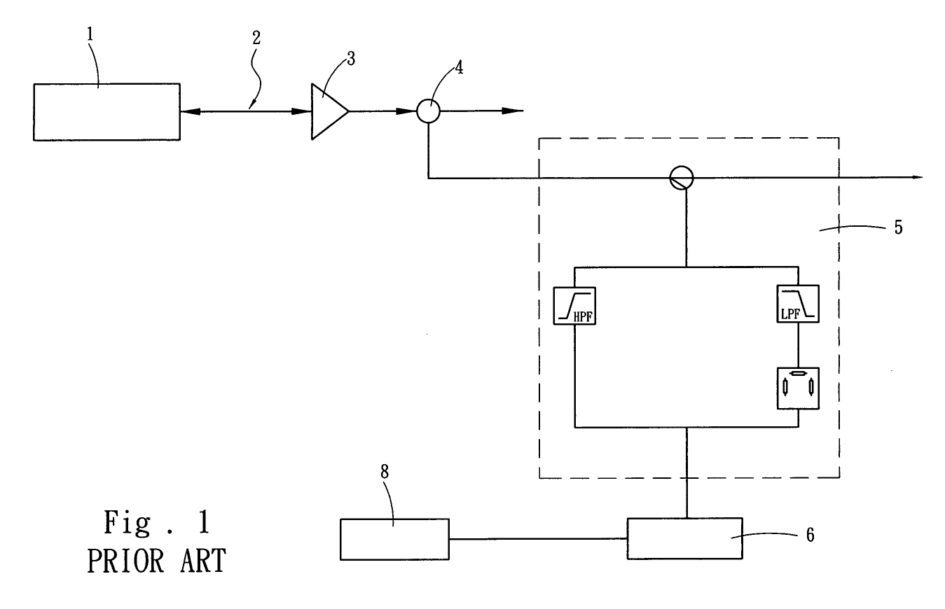

FIG. 2 is a block diagram illustrating a system of the present invention.

FIG. 3 is a flow chart illustrating an operational flow of the present invention.

FIG. 4 is a structural diagram illustrating the four-way splitter of the present invention.

FIG. 5 is a structural diagram illustrating the eight-way splitter of the present invention.

FIG. 6 is a block diagram illustrating another system of the present invention.

### DETAILED DESCRIPTION OF THE PREFERRED EMBODIMENTS

The objects and technical contents of the present invention will be better understood through descriptions of the following embodiment with reference to the drawings.

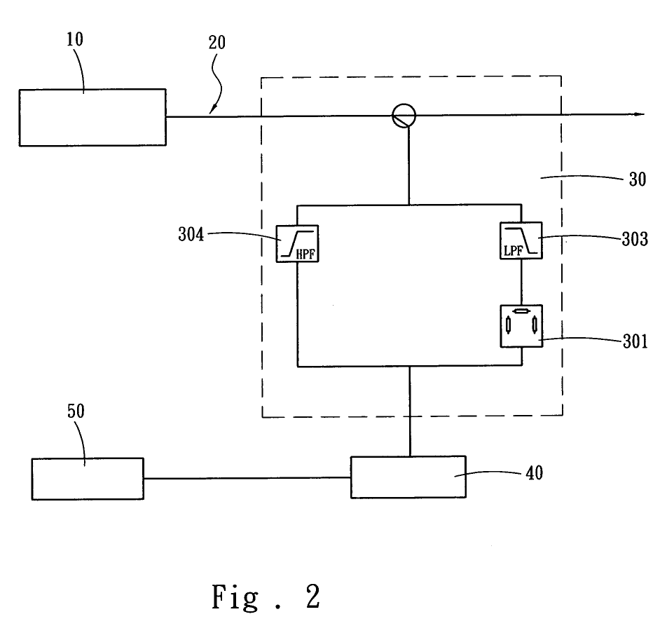

FIG. 2 is a block diagram illustrating a system of the present invention. Referring to FIG. 2, the system includes a machine room's end 10, a cable TV line 20, a splitter 30, and a user's end 40, wherein an attenuator 301, a high-pass filter 304, and a low-pass filter 303 are provided inside the splitter 30. The machine room's end 10 emits a downstream signal to the user's end 40 through the cable TV line 20 and splitter 30 so that the cable TV subscriber at the user's end 40 can receive the downstream signal and watch TV programs. Also, a cable modem 50 may be installed at the user's end 40 and a CMTS (not shown) may be installed at the machine room's end 10 so that the subscriber can log on to the Internet at the user's end 40 by means of the cable modem 50.

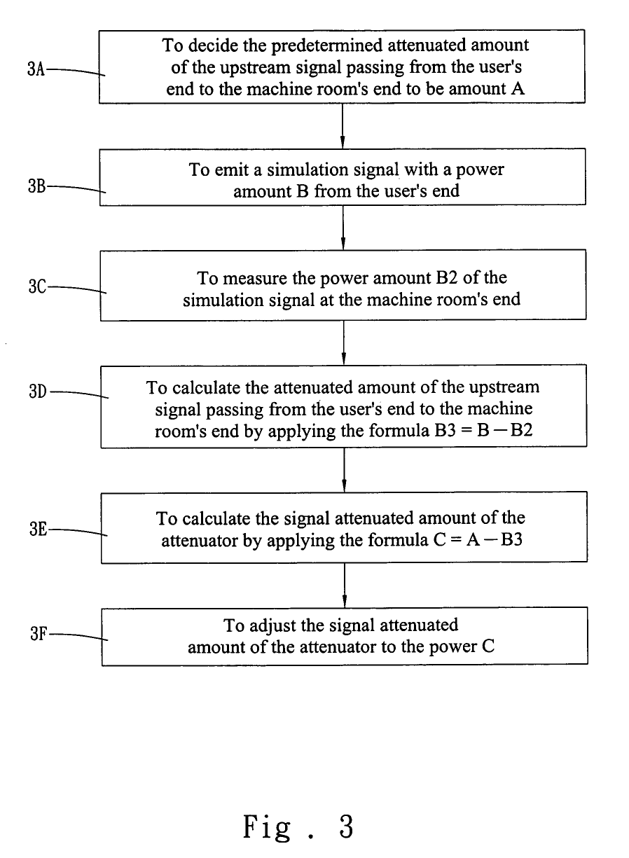

Next, referring to FIG. 3, which is an operational flow chart of the present invention, starting from step 3A to step 3F. The flow chart shows that the present invention will first decide the predetermined attenuated amount A of the upstream signal passing from the user's end 40 to the machine room's end 10, and the user's end 40 will emit a simulation signal with a power amount B. Then, the simulation signal will be transmitted to the machine room's end 10 through the cable TV line 20, and the simulation signal will be measured at the machine room's end 10 to obtain a power amount B2. After that, the power amount B2 of the simulation signal obtained from the machine room's end 10 will be compared with the original power amount B to obtain an attenuated power amount B3 of the upstream signal from the user's end to the machine room's end 10, wherein B3=B−B2.

In addition, the attenuator 301 can adjust the amount of signal attenuation, which is determined according to the attenuated amount B3 of the upstream signal from the user's end 40 to the machine room's end 10. If the optimal signal attenuated amount of the attenuator 301 is determined to be C, wherein C=A−B3, then as long as the signal attenuated amount of the attenuator 301 is adjusted to C, the upstream signal attenuation from the user's end 40 to the machine room's end 10 can also be adjusted to the amount A. Through the process, good quality of cable TV image viewing can be assured at the user's end 40, and the upstream signal can also be assured to have optimal power.

To illustrate the above-mentioned method, for example, suppose the predetermined attenuated amount of upstream signal from the user's end 40 to the machine room's end 10 is 40 dB, and suppose the power of simulation signal emitted from the user's end 40 is 55 dB and later on attenuated into an amount of 40 dB when measured in the machine room's end 10, the attenuated amount of the upstream signal will then be calculated as 15 dB from the user's end 40 to the machine room's end 10. Accordingly, the signal attenuated amount of the attenuator 301 will be adjusted to 25 dB, derived from 40 dB-15 dB. Then, the attenuated amount of the upstream signal from the machine room's end 10 to the user's end 40 can be adjusted to a fixed amount of 40 dB. Therefore, if the optimal receiving power of the upstream signal at the CMTS of the machine room's end 10 is 0 dB, then the machine room's end 10 can receive an upstream signal of 0 dB as long as the user's end 40 is allowed to emit a power of 40 dB upstream signal. Thus, all the cable TV subscribers will follow the same adjusting method to obtain the same upstream signal attenuation. As a result, all the noises coming from the user's end 40 will under control owing to the optimal upstream signal attenuation.

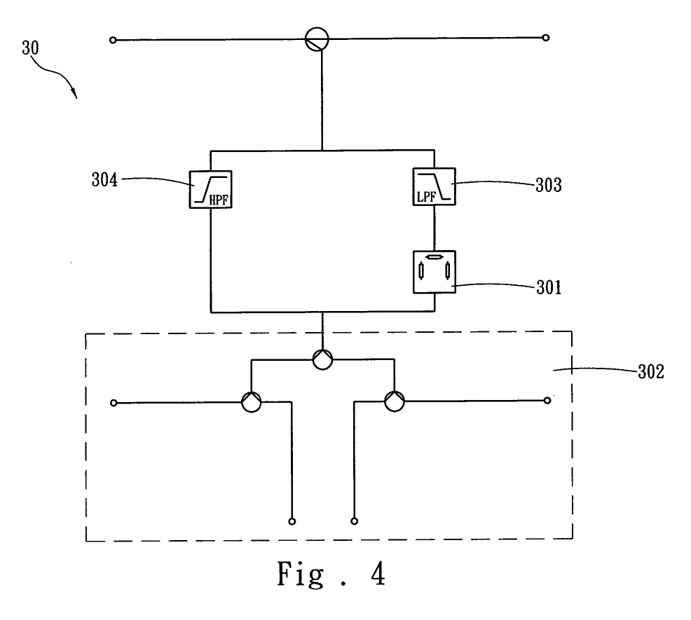

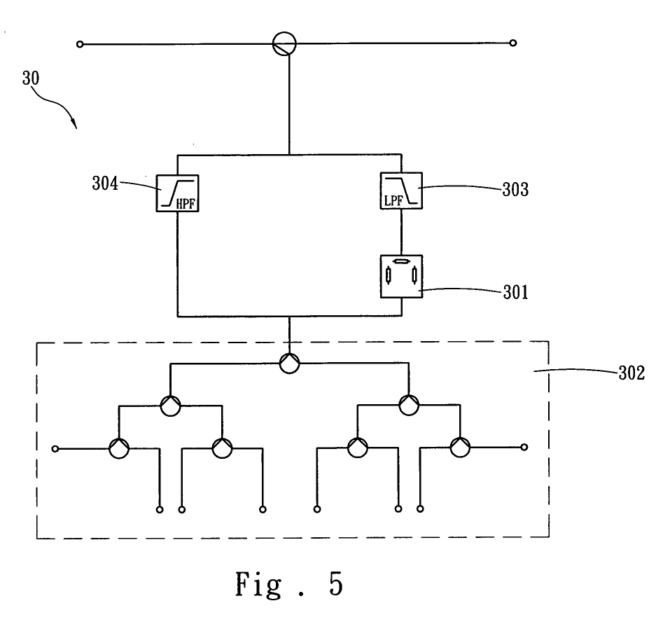

Next, referring to FIG. 4 and FIG. 5, the splitter 30 may have a plurality of branch points 302 capable of providing multiple upstream and downstream signals simultaneously in order to be suitable for congregate residence. The splitter 30 may be a two-way splitter, a four-way splitter (as shown in FIG. 4), or an eight-way splitter (as shown in FIG. 5), which can provide two, four, or eight upstream and downstream signals respectively to be used by the user's end 40.

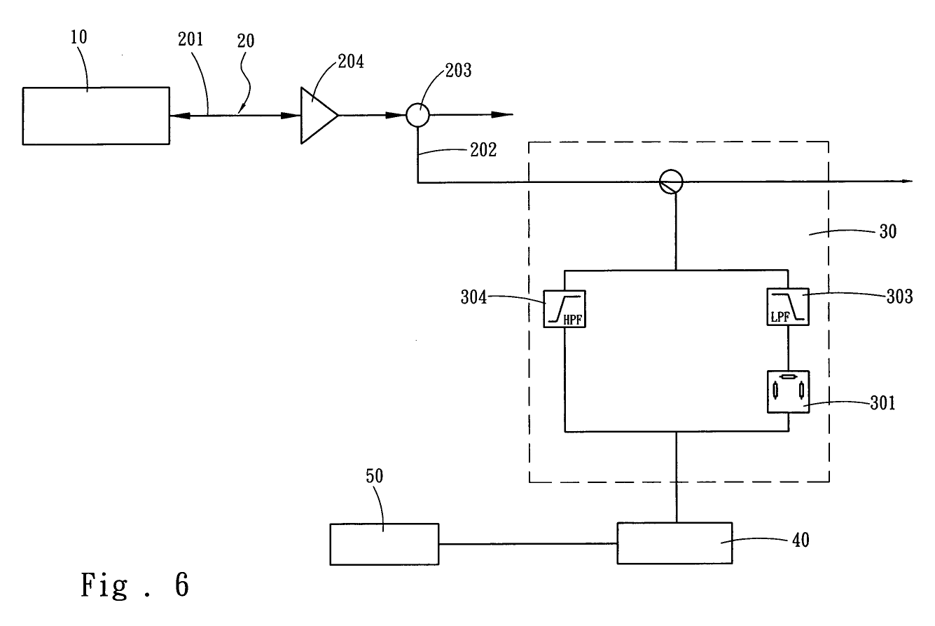

Furthermore, referring to FIG. 6, the cable TV line 20 can also include a major truck 201, a major trunk distributor 203, and a user's line 202. The major trunk 201 may apply the major trunk distributor 203 for branching the upstream and downstream signals to the user's line 202, whereas the user's line 202 may employ the splitter 30 for branching the upstream and downstream signals to the user's end 40. Also, at least one signal amplifier 204 is provided on the major trunk 201 to maintain stable power for the signals of major trunk 201 so that the upstream and downstream signals at the user's end 40 can be more stable.

To conclude, the present invention can adjust the upstream signal attenuation passing from the user's end 40 to the machine room's end 10 to a fixed amount through the foregoing method. Therefore, as long as the emitted power of the upstream signal is adjusted, the upstream signal received by the user's end 40 and the machine room's end 10 will have optimal power. Hence, the attenuated amount of the upstream signal can be prevented from being too small, and in turn interference made by the noise at the user's end 40 can be avoided. As a result, the problem of unrecognizable upstream signals at the machine room's end 10 can be well resolved.

What is claimed is:

1. A distribution method for noise control, which is used for adjusting the attenuated amount of an upstream signal passing from a machine room's end to an user's end, comprising the following steps:
to emit a simulation signal from the user's end, wherein the simulation signal will be transmitted to the machine room's end through a splitter and a cable TV line;
to receive and measure power of the simulation signal at the machine room's end, and through calculation, to obtain the attenuated amount of the upstream signal passing from the user's end to the machine room's end; and
to adjust the signal attenuated amount of the attenuator provided in the splitter according to the attenuated amount of the upstream signal passing from the user's end to the machine room's end.

2. The distribution method for noise control as claimed in claim 1, wherein the predetermined attenuated amount of the upstream signal passing from the user's end to the machine room's end is defined as A, the power amount of the simulation signal is defined as B, the power amount of the measured simulation signal at the machine room's end is defined as B2, the attenuated amount of the upstream signal passing from the user's end to the machine room's end is defined as B3, wherein B3=B−B2, and the signal attenuated amount of the attenuator is defined as C; the signal attenuated amount C of the attenuator will be adjusted so as to derive C=A−B3.

3. The distribution method for noise control as claimed in claim 1, wherein the splitter contains a plurality of branch points capable of providing a plurality of upstream and downstream signals.

4. The distribution method for noise control as claimed in claim 1, wherein the splitter is a two-way splitter for providing two upstream and downstream signals simultaneously.

5. The distribution method for noise control as claimed in claim 1, wherein the splitter is a four-way splitter for providing four upstream and downstream signals simultaneously.

6. The distribution method for noise control as claimed in claim 1, wherein the splitter is an eight-way splitter for providing eight upstream and downstream signals simultaneously.

7. The distribution method for noise control as claimed in claim 1, wherein the cable TV line includes a major trunk and a user's line, and the major trunk will employ a major trunk distributor for branching the upstream and downstream signals to the user's line and the splitter.
